(19) United States
(12) Patent Application Publication
(10) Pub. No.: US 2003/0232637 A1
(43) Pub. Date: Dec. 18, 2003

(54) Computer skills challenge game methodology

(76) Inventor: Hilbert M. McDougal, Jacksonville, FL (US)

Correspondence Address: Mark J. Young, McGuire Woods LLP, Suite 3300, 50 North Laura Street, Jacksonville, FL, 32202, US

(21) Appl. No.: 10/458,933

(22) Filed: Jun. 11, 2003

Related U.S. Application Data
(60) Provisional application No. 60/388,573, filed on Jun. 12, 2002.

(51) Int. Cl. A63F 13/00

(52) U.S. Cl. 463/9; 273/430; 463/40; 463/41; 463/42

(57) ABSTRACT

A game allows contestants to access the Internet to answer questions, including solving problems. Contestants compete to quickly find answers to questions (and/or solutions to problems) using the Internet, with the first contestant to answer winning a prize or scoring points for that question. A contestant may be an individual or a plurality of individuals comprising a team. Contestants may be located in the same location or in geographically remote locations. After a determined number of questions, or a determined amount of time, the contestant with the most points wins the game and preferably a prize. Other contestants may receive consolation prizes. The winner may also advance to a timed bonus round for a grand prize. Ties between contestants may be resolved in a tiebreaker round.

### BENEFIT CLAIM UNDER 35 U.S.C. §119(e)

This application claims priority to U.S. Provisional Application 60/388,573, filed Jun. 12, 2002, the entire contents of which are hereby incorporated by reference herein.

### FIELD OF THE INVENTION

The present invention relates to a game show. In particular, the present invention relates to a game that requires contestants to obtain answers to questions from the Internet.

### BACKGROUND

Over the years many game shows have tested contestants' knowledge in many ways. For example, the popular quiz show, Jeopardy™, rewards a contestant for correct answers. On the Weakest Link™ game show contestants vote to eliminate a fellow competitor they deem to be the weakest link (i.e., least knowledgeable). While such games have proven to be entertaining and stimulating, they have several shortcomings.

One shortcoming is that such games tend to cater to the strengths of highly educated and worldly individuals. Success often depends exclusively upon a contestant's knowledge of esoteric facts and arcane subjects. Such topics may be beyond the grasp of many individuals, making the game seem boring or annoying to them.

Another shortcoming is that such games neither challenge a contestant's research skills nor reward a contestant's resourcefulness. In day-to-day affairs, knowing how and where to find an answer are often as important as the answer itself. Yet conventional game shows require contestants to know or guess an answer.

One of the most valuable research tools of modern times, namely the Internet, has not, heretofore, been integrated into game shows. The Internet, particularly the World Wide Web, provides access to a wealth of information on countless topics contributed by people throughout the world. Unlike a conventional library in which all resources are identifiable and retrievable through a single catalog, no one knows how many individual resources are accessible via the Internet. The number certainly runs into the many millions or billions and is growing at a rapid pace.

The Internet is a unique unprecedented research tool, with countless traps for the unwary and the capacity to accommodate countless concurrent users. Anyone with a small amount of technical skill and access to a host computer can publish on the Internet. Thus, some sites demonstrate an expert's knowledge, while others illustrate amateur efforts and ignorance, and others highlight nonsense and fetishes. Internet sites also change over time according to the commitment and inclination of the creator. Some may be updated daily, while others may be outdated, and others disappear.

Furthermore, as Internet sites may be accessed by many users concurrently, home viewers may readily play along and test their skills against contestants. These features of the Internet make it particularly attractive for use on a game show.

Thus, a game is needed that enables contestants to search for answers on the Internet.

### SUMMARY

The present invention provides a game that requires or allows contestants to access the Internet to answer questions and/or solve problems. Contestants having computers with Internet access compete to quickly answer questions, with the first contestant to answer winning a prize or scoring points for that question. A contestant may be an individual or a plurality of individuals comprising a team. Contestants may be located in the same room or in geographically remote locations.

In a preferred embodiment, answers must come from an Internet website. In another embodiment, answers may come from an Internet website, or the contestant may guess the answer or state the answer from his/her own knowledge.

In a preferred embodiment, after a determined number of questions, or a determined amount of time, the contestant with the most points wins the game and preferably a grand prize. Other contestants may receive consolation prizes, for example equally or with prizes valued according to a contestant's place (e.g., 2^{nd} place, 3^{rd} place and so on). The winner may advance to a bonus round. Ties may be resolved in a tiebreaker round.

It is, therefore, an object of the present invention to provide a question and answer game that allows contestants to find answers on the Internet.

It is another object of the present invention to provide a question and answer game that rewards a contestant who finds an answer on the Internet before other contestants.

It is also another object of the invention to provide a question and answer television game show that allows home viewers to compete against televised contestants.

### BRIEF DESCRIPTION OF THE DRAWINGS

The foregoing and other objects, features and advantages of the present invention will become better understood with reference to the following description, appended claims, and accompanying drawings, where:

FIG. 1 is a diagram that conceptually depicts an exemplary computer network for use in accordance with an implementation of the present invention; and

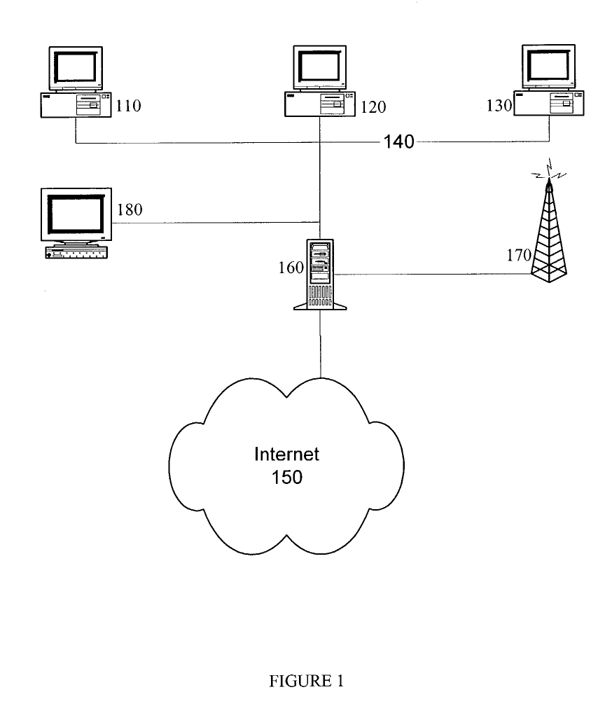

FIG. 2 is a flowchart that conceptually depicts steps of an exemplary game in accordance with an implementation of the present invention.

### DETAILED DESCRIPTION

A system for playing a game in accordance with an exemplary embodiment of the present invention includes one or a plurality of terminals 110-130 communicatively connected to one or more networks 140, including the Internet 150. Each terminal is preferably comprised of a computer system, preferably having a bus for communicating information, a central processing unit (CPU), a read only memory (ROM), a random access memory (RAM), a mass storage device, a display device and an input device.

The storage device may include a hard disk, CD-ROM drive, DVD drive, tape drive, memory (e.g., RAM, ROM, Compact Flash RAM, PCMCIA RAM) and/or other storage equipment. The input device may include a keyboard, touch sensitive screen, a pointing device (e.g., a computer mouse, touch pad or joystick) and the like. Software such as an operating system and Internet browser are preferably stored on and executable on the terminal. These elements are typically included in many computer systems known in the art, and the aforementioned terminal is intended to represent a broad category of computer systems capable of supporting Internet access and research in accordance with the present invention. Of course, the terminals may include fewer, different and/or additional elements, provided each is capable of performing determined functions in accordance with the present invention.

In a preferred implementation, an exemplary game in accordance with the present invention is played as a televised game show. A host presents questions to a plurality of contestants. Each contestant may be an individual or a plurality of individuals (e.g., a team). The contestants may be located in the same facility (e.g., a television studio) or in separate facilities (e.g., studios in different cities). The contestants compete for the best score and/or prizes based upon their performance, as discussed more fully below.

Those skilled in the art will appreciate that versions of the game that are not televised game shows are readily feasible and come within the scope of the present invention. While a televised game show is a preferred implementation, the present invention may be implemented, for example, as a play-at-home version or a play at a club (e.g., at an Internet cafe) version without departing from the scope of the present invention.

In an alternative implementation, a single contestant may play the game. Again, the contestant may be an individual or a plurality of individuals. Instead of competing head-to-head with other contestants, the playing contestant may compete against time, a prior contestant's score or a determined minimum score. For example, a determined amount of time may be given, or the playing contestant may perform an act (e.g., roll dice, spin a wheel or the like) to determine a minimum score or an amount of time allowed to correctly answer a question.

To play the game, each contestant is provided access to a computer terminal having Internet access. In a preferred implementation, as discussed above, each contestant uses a comparably equipped computer with comparable Internet access capability. By way of example and not limitation, contestants in a studio may have access to a computer equipped with an Intel Pentium IV processor, 512 Mbytes of random access memory (RAM), the latest version of Microsoft Windows® operating system, the latest version of Microsoft's Internet Explorer, a 20 Gbyte hard drive, a keyboard, a mouse, a seventeen inch LCD display, and an Ethernet card with access to a router having a T-1 communications link to the Internet. However, the present invention is not limited to any specific computer, operating system, Internet browser software, input devices, display device or Internet network connectivity.

In another implementation, contestants may be given an opportunity to supply or configure the computers they use to play the game. For example, contestants may be required to supply their own computer. Guidelines may be established regarding the performance, size and compatibility of each computer. Limits may be established regarding the central processing unit, random access memory, hard disk, operating system, Internet browser software, input devices, display device and/or network connectivity. In this version of the game, a contestant's performance will depend, at least in part, upon the integrity and performance of the contestant's computer, much like NASCAR® drivers depend upon their cars and Battlebots® contestants depend upon their robots. Advantageously, the resourcefulness and creativity of contestants adds an exciting dimension to the game. Before each game, contestants may be given an opportunity to describe their computers.

In a preferred televised version of the game, a television broadcast unit 170 outputs a television signal, which can be received by viewers via their television receivers in a conventional manner. Such reception may be via satellite dish, cable television, UHFNHF roof-top antenna, or the like. The system server may obtain information from contestants' terminals. The broadcast unit may obtain such information from a server 160 and broadcast all or portions of such information for viewing by viewers.

In a preferred televised version of a game in accordance with the present invention, a host presents questions for contestants to answer. The host is preferably equipped with a terminal 180 for receiving and reading questions. In a play at home version of the game, a non-contestant may be the host. Alternatively, contestants may take turns being the host or the contestant who wins a round may be the host for the next question. In another alternative, questions may appear on a screen visible to the contestants and/or on each contestants' computer terminal. Thus, the means for presenting questions may include a host and/or one or more displays, and/or one or more tangible media of visual expression (e.g., cards).

Questions may be randomly selected from a plurality of pre-determined questions. Alternatively, pre-determined questions may be presented in a pre-determined order. The host may read each question to the contestants, such as from an index card or a display 180. By way of example, a question may appear on a large screen that is visible to a studio audience and communicatively connected to the television broadcast unit. In a play at home version, questions may be provided on printed cards, via the Internet or stored on computer-readable media (e.g., CD-ROMs).

Contestants have a determined amount of time to answer a question. The time is measured from the moment a question is read by the host, displayed to the contestants or a subsequent starting signal (e.g., a green light) has been activated. A timer is preferably provided. An alarm may sound if a determined amount of time is reached and no answer has been locked in. If a contestant does not lock in a correct answer within a determined amount of time, then no points are awarded for that question. In one embodiment, the timer may disable the means for locking in an answer once the alarm has been triggered, until the timer is reset for a new round. Thus, the timer provides a means for determining if the contestants exceed a determined amount of time to find and lock in the answer from the Internet for a question.

To answer a question, contestants may access and search the Internet via the contestants' computer terminals. The first contestant to lock in an answer to the question is awarded points for that question. A contestant locks in an answer by performing an affirmative act, such as by selecting an icon, pressing a key combination, pressing a button, raising a hand, or stating something. Thus, a means for locking in answer identifies the first contestant to perform the affirmative act within a determined time. By way of example and not limitation, a software enabled icon on a contestant's screen may trigger a screen capture allowing the contestant to capture an Internet website displayed on the contestant's computer terminal and may also transmit to the server the identity of the contestant to first select the icon. Alternatively, a software-enabled key combination pressed on a keyboard may provide the means for locking in answer. In another alternative, buttons adjacent to contestants' computer terminals may signal the identity of the first contestant to press the button.

Means for scoring the one or more contestants according to performance in finding and locking in an answer to the question. By way of example, and not limitation the means for scoring may include a software-enabled system of awarding points corresponding to monetary amounts (e.g., $5,000) for locking in an answer to a question first. If a contestant locks in an incorrect answer, the contestant may be penalized by deducting a determined amount of points, even if the total points becomes negative for that contestant. The total score for each contestant may be displayed.

Each question and answer is a round of play. At the end of a determined number of rounds, the contestant with the most points wins. Other contestants may receive consolation prizes, for example equally or with prizes valued according to a contestant's place (e.g., 2^{nd} place, 3^{rd} place and so on). Ties may be broken in tiebreaker rounds. The winner may be awarded a prize and have an opportunity to play a bonus round (e.g., an additional timed round) for a grand prize.

Answers to questions are preferably unlikely to be immediately known to the contestants. In a preferred implementation of a game in accordance with the present invention, contestants will not know the answers to the questions and will have to access the Internet to find the answers. In one implementation, even if a contestant knows the answer, the contestant must still find an Internet website that provides the answer.

As used herein, the term question refers to conventional questions (e.g., What is the title of the last chapter of Charles Dickens' A Tale of Two Cities? or, in what year was Sir Isaac Newton's book known as the Principia first published?), as well as to requests and problems. By way of example, a request may ask a contestant to show or play one or more things (e.g., show us a picture of Henri Rousseau's painting Sleeping Gypsy). A question may also require a contestant to solve a problem (e.g., what is the straight-line distance from New York, N.Y. to New Orleans, La.? or what is the weight in pounds of one cubic foot of titanium?) such as by referring to a map, table or other reference material on one or more Internet websites. Advantageously, the present invention accommodates a wide range of question types, including those requiring a contestant to find an image, audio clip or other multimedia accessible on the Internet.

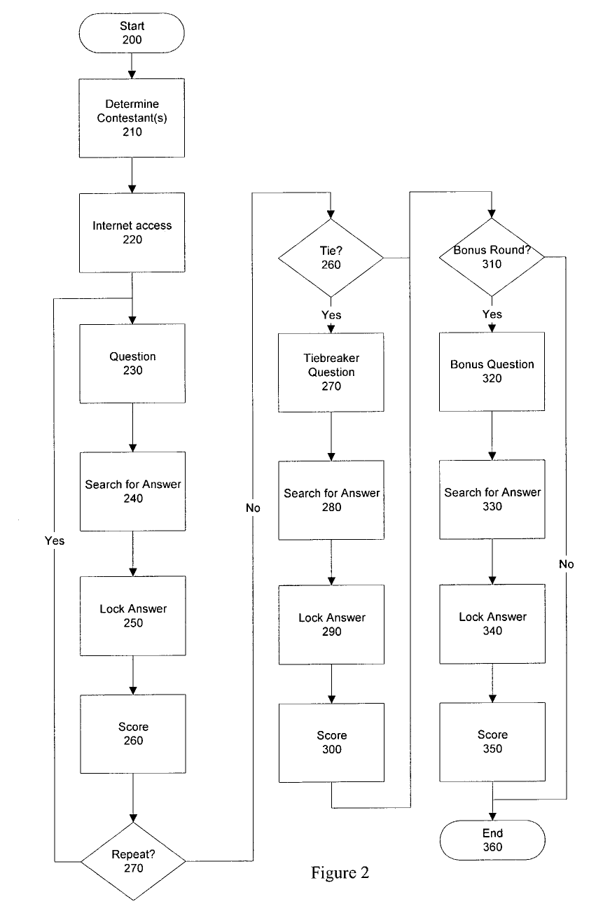

Referring now to FIG. 2, a flowchart of an exemplary game methodology in accordance with the present invention is conceptually shown. The methodology entails selecting or determining contestants 210. The selection may be accomplished by random drawing from a pool of candidates, application and try-outs, or any other method for selecting game contestants.

Next, Internet access is enabled for each contestant 220. Thus, each contestant may surf the Internet, including the World Wide Web, to find answers to questions.

Next, a question is presented to the contestants 230. The contestants then have a determined amount of time to lock in an answer 240. Scoring entails adding or deducting points 250. The first contestant to lock-in a correct answer wins points for that question. A contestant who locks in a wrong answer loses points for that question. The steps of question, answer and scoring 230-250 repeat until the end of the game play. At the end of game play, any tie scores are broken in a tie-breaker round 260-300 among the tied contestants.

After the end of game play, the contestant with the highest score may have an opportunity to play a bonus round 310-360. Within a determined amount of time, the contestant may lock-in a correct answer to win bonus points for that question, lock in a wrong answer and lose points for that question, or not lock in an answer, in which case the contestant may either lose points or not lose points.

The foregoing detailed description of particular preferred implementations of the invention, which should be read in conjunction with the accompanying drawings, is not intended to limit the enumerated claims, but to serve as particular examples of the invention. Those skilled in the art should appreciate that they can readily use the concepts and specific implementations disclosed as bases for modifying or designing other methods and systems for carrying out the same purposes of the present invention. Those skilled in the art should also realize that such equivalent methods and systems do not depart from the spirit and scope of the invention as claimed.

Having thus described the present invention, what is claimed as new and desired to be secured by Letters Patent is as follows:

1. A game methodology comprising steps of
(a) determining one or more contestants;
(b) enabling Internet access for the one or more contestants;
(c) presenting a question to the one or more contestants;
(d) allowing the one or more contestants a determined amount of time to find and lock in an answer from the Internet for that question;
(e) and scoring the one or more contestants according to performance in finding and locking in an answer to the question.

2. A game methodology according to claim 1 wherein steps (c) through (d) are repeated for a plurality of questions.

3. A game methodology according to claim 1 further comprising steps of
presenting a bonus question to one of the one or more contestants;
allowing the one of the one or more contestants a determined amount of time to find and lock in an answer from the Internet for that bonus question;
and scoring the one of the one or more contestants according to performance in finding and locking in an answer to the question.

4. A game methodology according to claim 1 wherein steps (c) through (d) are repeated for a plurality of questions, and said methodology further comprises steps of
presenting a bonus question to one of the one or more contestants;
allowing the one of the one or more contestants a determined amount of time to find and lock in an answer from the Internet for that bonus question;
and scoring the one of the one or more contestants according to performance in finding and locking in an answer to the question.

5. A game methodology according to claim 1 further comprising the step of televising the one or more contestants.

6. A game methodology according to claim 4 further comprising the step of televising the one or more contestants.

7. A method of playing a game comprising steps of
receiving a question,
using a computer with Internet access to find an answer to the question on the Internet,
locking in the answer when the answer is found, and
earning a score according to performance in finding and locking in the answer to the question.

8. A system for playing a game comprising a computer with Internet access for each of one or more contestants;
means for presenting a question to the one or more contestants;
means for locking in an answer from the Internet for that question; and
means for determining if the each of one or more contestants exceed a determined amount of time to find and lock in the answer from the Internet for that question.

9. A system for playing a game according to claim 8, said system further comprising means for scoring the one or more contestants according to performance in finding and locking in an answer to the question.
